(19) United States
(12) Patent Application Publication
(10) Pub. No.: US 2012/0153804 A1
(43) Pub. Date: Jun. 21, 2012

(54) ULTRAVIOLET COLD CATHODE FLORESCENT LAMP

(76) Inventor: Yu Jen Li, Taipei Hsieng (TW)

(21) Appl. No.: 12/972,405

(22) Filed: Dec. 17, 2010

(51) Int. Cl. H01J 63/04

(52) U.S. Cl. 313/485

(57) ABSTRACT

The present invention is related to a UV CCFL lamp, and more particularly, to a UV CCFL lamp for curing a nail gel with a UVA irradiation having a peak wavelength of such as 366 nm or 368 nm in the field of nail art. In order to provide a UV CCFL lamp capable generating ultraviolet light of high intensity and uniform lighting with great electrical safety and reliability, the UV CCFL lamp of the present invention comprises a translucent hermetic envelope configured to enclose a discharge medium and a UV-excited phosphor to generate the desired UV irradiation preferably in the UVA spectrum range. The discharge medium is preferably to be a mercury-ion vapor and distributed throughout and sealed within the lamp envelope to be excited to a plasma state and for producing a first emission spectrum of a UVC wavelength during operation; and the phosphor in contact with the mercury-ion vapor plasma preferably comprises a composition of either europium-doped boron strontium oxide (B₄SrO₇:Eu⁺) or europium-doped strontium fluoborate (SrFB₂O_{3.5}:Eu²⁺) for producing said UV irradiation in response to said first emission spectrum of the discharge medium. To provide a uniform UV irradiation output from the UV CCFL lamp of the present invention, the phosphor is advantageously prepared to be of a mean grain size of 8.5 μm±3 μm for SrFB₂O_{3.5}:Eu²⁺ and of 15 μm±3 μm for B₄SrO₇:Eu⁺.

### FIELD OF THE INVENTION

The present invention relates to a ultraviolet (UV) curing lamp, and more particularly, to a UV cold cathode florescent lamp (CCFL) utilizing a UV-excited UV phosphor for converting UV wavelength of light to solidify a particular nail gel applied onto the nails of human fingers and toes as well as those of animal pets.

### BACKGROUND OF THE INVENTION

The professional field of nail art has been widely introduced worldwide and has grown to adapt various new technologies as the development of both lighting and nail gel composition improves. In general, nail art may refer to the makeup or decoration of nails of fingers and toes. Conventional nail art may use either a resin or a gel type of artificial composition polymerizing at room temperature to form artificial nails. More advanced nail gel capable of forming or polymerizing into artificial nails in a relatively shorter duration of time may utilize a UV irradiation to enhance such curing or polymerizing process.

There exist incandescent UV lamps adapted for various lighting fixtures in various industrial and commercial applications. Conventional UV incandescent lamps mostly include a coating or wavelength filtering layer/film to achieve the desired purpose of UV lighting including the emission of different spectrum ranges of UVA, UVB and UVC. However, with regard to the use of such UV incandescent lamps in the field of nail art, there are at least two major concerns associated with the use of such incandescent lamps in the field. One is the hazard of having human skin exposed to UV rays under these UV incandescent lamps or bulbs may lead to undesirable skin cancer in a long run since UV incandescent lamps typically emit three types of UV light in reference to skin protection and these are UVA (wavelength 400 nm-315 nm), UVB (wavelength 315 nm-280 nm), and UVC (wavelength 280 nm-100 nm). It is important to know that among the three rays, UVC of wavelength, or in terms of energy, of 280 nm-100 nm is the most damaging and is the most energetic of the three types. Another major drawback deals with the relatively short lifetime of UV incandescent lamps that may require frequent maintenance. A typical UV incandescent lamp has a lifetime of 3,000 hrs (or approximately 4 months) and upon which replacements must be performed and may not be optimal if fixtures or machinery adopting such UV lamps include delicate components and/or electrical plugs and/or circuitries.

Recent technology advancements in lighting also make compact florescent lamp (CFL) and light emitting diode (LED) lighting possible in various commercial and industrial applications. CFL lamps are known for being of relatively energy saving in the field of general lighting while capable of producing a sufficient illumination with great angles; however, the current spiral shapes and sizes of the light tube or envelope adopted therein tend to be problematic if any UV-excited compound is to be introduced therein to respond to mercury plasma excited and contained therein during operation in order to produce or achieve a desired uniform lighting with sufficient lumen output. In other words, it is found that the current or standard shapes and structures of CFL cannot efficiently or desirably produce a uniform UV irradiation by simply introducing UV-excited compound therein to respond to or with the mercury ion vapor or plasma contained therein. Furthermore, LEDs composing of semiconductor materials may too be utilized to produce UV irradiation. The wavelength of the light emitted of LEDs is a function of the band-gap energy of the materials used in the p-n junction. As LEDs are known for their great efficiency in transforming electricity into light; nevertheless, current UV LEDs or LEDs capable of emitting wavelength in the UV spectrums are yet to be developed to be as efficiency as common LEDs in visible wavelength. In fact, it is found that due to the limitation of current UV LEDs emitting UV irradiation in the UV spectrum ranges are far from being considered as efficient as other known LEDs in visible spectrums. Furthermore, UV LEDs like most current LEDs are limited by their illumination angle as being a point light source, which may require multiple modules for an illumination area and in term may undesirably increase the overall material and installation costs, in comparison to the same illumination output and area given under incandescent or CFL lightings. Greater power is required to produce a sufficient or desired UV irradiation from a current UV LED, which in term may too increase the operating temperature or junction temperature of the UV LED, making it undesirable or an unpractical solution to the current UV irradiation and application up to this very date.

As for the field of nail art, it is also known that the time of curing and the appearance of a nail gel after curing are crucial for artificial nails. In other words, in order to complete the curing process in a relatively shorter curing time as mentioned previously, the nail gel shall respond to UV irradiation such that the gel may, in term, be polymerized or solidified within a prescribed period of time. A commercially available nail gel may be a high-viscosity liquid material containing a (meth)acryl-based monomer capable of polymerizing or solidifying under normal room temperature after a certain period of time. While comparing to traditional resin type of nail gel, these gel type of artificial nail may cause less odor or skin irritation and may too have greater operability. However, yellowing of a cured artificial nail of gel type nails may still occur and may thus fail to meet aesthetic demands of consumers. Another factor being that the curing or solidification process of typical nail gel generally requires a significant of process time and may or may not be involving and a photopolymerization initiator. It is known that such photopolymerization initiator is a crucial component for a certain nail gel to respond to UV rays such that it may be effectively cured by UV irradiation.

In view of the above and with regard to the field of nail art, it may therefore be optimal that both the UV light source as well as the type of nail gel to be cured by UV irradiation of the UV light source are to be considered altogether such that at least the UV irradiation lamp may be of great energy efficiency, the adverse influence of UV rays, in particular the UVC of wavelength between 280 nm-100 nm, on the human body may be reduced and the outcome including the appearance of the nail gel of artificial nails of such UV curable systems may be desirably obtained. In other words, there is a need for a UV lamp capable of overcoming the drawbacks of the known arts including the ones of incandescent, CFL and LED lamps recited above while being able to produce a safe, reliable, efficient UV irradiation, particularly, in the field of nail art and for a nail gel curable under such UV irradiation. Furthermore, it is also desirable to provide an UV lamp to facilitate the creation of nail arts and nail protections of multiple fingers or toes all at once safely and effectively with high reliability.

### SUMMARY OF THE INVENTION

In order to overcome the shortcomings described above, one aspect of the present invention is to provide an UV CCFL light bulb capable of curing an UV hardening or polymerizable gel such as an acrylic gel may respond to a UV irradiation to be polymerized or solidified from a liquid to a solid state safely and uniformly with an UV irradiation. It is also preferable that the UV irradiation provided by the UV CCFL lamp of the present invention is sufficient to cure a certain type of nail gel effectively and efficiently in terms of luminous efficacy (lm/W) required such as in comparison with the ones of a known incandescent or LED lamp. The irradiation is preferably of an illumination angle of 360 degrees such that the UV irradiation provided by the UV CCFL of the present invention is substaintially uniform in various directions.

Another aspect of the present invention is provide a UV CCFL lamp for curing a UV curable nail gel with a UV irradiation capable of facilitating the curing of the nail gel to achieve an optimal result. It is preferable UV CCFL lamp may be preferably provided for a collaborative use with a particular type of nail gel. It may too be preferable that in order to achieve an optimal curing result from the UV irradiation of the UV CCFL lamp of the present invention, a UV curable nail gel may be of a composition comprising a first component having at least one radical polymerizable unsaturated double bond in the molecule and a second component of photopolymerization initiator.

Still another aspect of the present invention is to provide a UV CCFL lamp capable of producing a safe UV irradiation preferably in the UVA spectrum range such as wavelength between 400 nm-315 nm. It is preferable that a UV CCFL lamp of the present invention utilizes a UV-excited phosphor comprising an europium-doped composition to produce or generate such safer UVA irradiation and in particular, for nail gel curing in the field of nail art particularly for human uses.

Still another aspect of the present invention is to provide a UV CCFL lamp utilizing the abovementioned UV-excited phosphor and advantageously configured to provide a substantially uniform irradiation output. It is preferable that the lamp envelope, including its dimension and shape, is advantageously configured to facilitate the bombardment or reaction of UV light rays with said phosphor disposed in the lamp envelope such that a relatively uniform UV irradiation may be obtained.

In one embodiment of the present invention, a UV CCFL lamp for curing a UV curable nail gel with a UV irradiation is provided. It is also preferable that the UV CCFL lamp of the present invention may provide UV irradiation for curing a particular type of nail gel such as one that may be of a composition comprising a first component having at least one radical polymerizable unsaturated double bond in the molecule and a second component of photopolymerization initiator. The UV CCFL lamp of the present invention may comprise a translucent envelope preferably in a spiral shape, discharge electrodes attached to the envelope or bulb shell, a discharge medium comprising an excited-ion-vapor plasma sealed within the translucent hermetic envelope for producing a first emission spectrum of a UVC wavelength (such as 280 nm-100 nm) and a lamp base comprising a power supply for supplying an electricity to excite said discharge medium and attached to the envelope and the discharge electrodes. In order to provide a UVA irradiation from said UVC emission spectrum produced by the discharge medium, the UV CCLF lamp of the present invention may further comprise a phosphor disposed within said translucent envelope and in contact with said discharge medium such that the UVC ultraviolet light ray may bombard with the phosphor therein to produce the desired UVA irradiation output. According to one embodiment of the present invention, said phosphor may comprise a composition of europium-doped boron strontium oxide (B₄SrO₇:Eu⁺) for producing said UV irradiation in response to said first emission spectrum of the discharge medium.

According to another embodiment of the present invention, a UV CCFL lamp for curing a UV curable nail gel with a UV irradiation is provided. It is also preferable that the UV CCFL lamp of the present invention may provide UV irradiation for curing a particular type of nail gel such as one that may be of a composition comprising a first component having at least one radical polymerizable unsaturated double bond in the molecule and a second component of photopolymerization initiator. In addition, the amount of the second component of the composition of the nail gel may be 0.05 to 4.00 parts by weight with respect to 100 parts by weight of said first component of the composition of the nail gel. The UV CCFL lamp of the present invention may comprise a translucent envelope preferably in a spiral shape, discharge electrodes attached to the lamp envelope or bulb shell, a discharge medium comprising an excited-ion vapor sealed within the translucent hermetic envelope for producing a first emission spectrum of a UVC wavelength and a lamp base comprising a power supply for supplying an electricity to excite said discharge medium and attached to the envelope and the discharge electrodes. In order to provide a UVA irradiation (such as wavelength between 400 nm and 350 nm) from said UVC emission spectrum produced by the discharge medium, the UV CCLF lamp of the present invention may further comprise a phosphor disposed within said translucent envelope and in contact with said discharge medium such that the UVC ultraviolet light ray may bombard with the phosphor therein to produce the desired UVA irradiation output. According to one embodiment of the present invention, said phosphor may comprise a composition of europium-doped strontium fluoborate (SrFB₂O_{3.5}:Eu²⁺) for producing said UV irradiation in response to said first emission spectrum of the discharge medium.

As UV irradiation provided by a UV CCFL lamp of the present invention is preferably to be uniform and of sufficient power or luminous efficacy, according to one embodiment of present invention, the lamp envelope enclosing the abovementioned exemplary embodiments of UV-excited phosphor to produce a non-UVC irradiation, preferably a UVA irradiation, may be advantageously configured to be of a spiral tubular shape having a substantially circular cross section with a diameter selected and manufactured to facilitate the bombardment of the phosphor power with the emission of ultraviolet rays initially produced by the discharge medium excited to a plasma vapor form such that a uniform irradiation output of UVA spectrum or wavelength of the UV CCFL lamp of the present invention may be obtained.

Furthermore, to advantageously provide a uniform UV irradiation output, preferably in a UVA spectrum range, the abovementioned UV-excited phosphor prepared to be disposed in a lamp envelope of the UV CCFL lamp of the present invention may be in a powder form such that the bombardment of the phosphor with the ultraviolet light ray produced by ion-excited vapor of the plasma of the discharge medium may be increased and enhanced. In one embodiment, the phosphor may comprise a composition of europium-doped boron strontium oxide (B₄SrO₇:Eu⁺) having a mean grain size between 12 μm and 18 μm. In another embodiment, the phosphor may comprise a composition of europium-doped strontium fluoborate (SrFB₂O_{3.5}:Eu²⁺) having a mean grain size between 5.5 μm and 11.5 μm.

The foregoing summary recites preferred embodiments of the present invention and is for illustrative purposes. Embodiments of the present invention may be implemented in various different ways and shall too be considered as part of the present invention within its scope. Details of the exemplary embodiments of the present invention will be further described in the following.

### BRIEF DESCRIPTION OF THE DRAWINGS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

FIG. 1 is a front perspective view of an UV CCFL lamp according to one embodiment of the present invention;

FIG. 2 is top view of the UV CCFL lamp of the present invention in FIG. 1;

FIG. 3 is an enlarged view of portion I of the lamp envelope of the UV CCFL lamp in FIG. 2, showing an illustrative mercury ion-vapor of a discharge medium and a UV-excited phosphor coating therein; and

FIG. 4 is a sectional view along line A-A in FIG. 3 of the lamp envelope of the UV CCFL lamp according to one embodiment of the present invention.

### DESCRIPTION OF EMBODIMENTS OF THE INVENTION

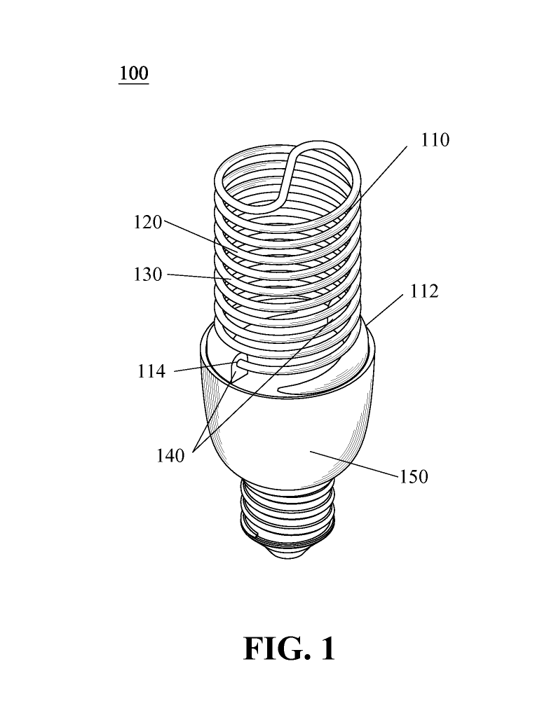

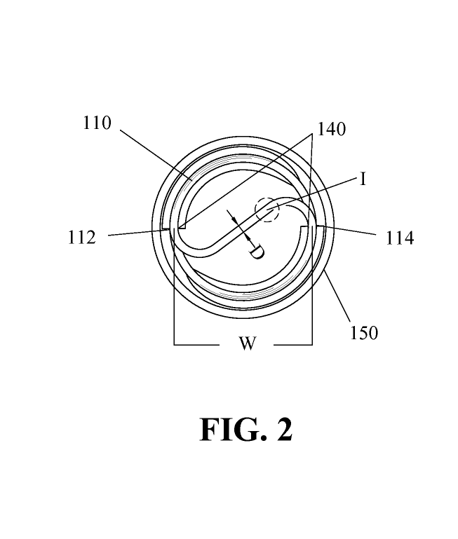

FIGS. 1 and 2 show an exemplary embodiment of a UV CCFL lamp 100 of the present invention, the UV CCFL lamp 100 is provided for curing a UV curable or polymerizable gel and more particularly, the UV CCFL lamp 100 may be advantageously provided for curing a nail gel in the field or application of nail art with a UV irradiation preferably in a non-UVC spectrum range such as wavelength of UVA (400 nm-315 nm) or UVB (315 nm-280 nm) to ensure a safer and healthier usage. In an explanatory example, the UV CCFL lamp 100 of the present invention may comprise a lamp envelope 110, a discharge medium 120 having ions excited to a plasma state by a high voltage electricity provided at discharge electrodes 140 attached to and configured on two ends 112, 114 of the lamp envelope 110. A UV-excited phosphor 130 may too be disposed within the lamp envelope 110 of the UV CCFL lamp 100 of the present invention and distributed to be in contact with said discharge medium 120 to provide a UV irradiation preferably in a non-UVC spectrum range. The UV CCFL lamp 100 of the present invention may too further comprise a lamp base 150 coupled to said lamp envelope 110 and configured to receive said discharge electrodes 112, 114. To provide or supply the abovementioned high voltage electricity to excite the discharge medium 120 enclosed in the lamp envelope 110, the lamp base 150 may too comprise a power supply (not show) adapted to a fixture and electrically connected to an external power source preferably on-grid.

The merits of a CCFL lamp in comparison to traditional incandescent lamps, compact fluorescent lamps CFL and LED lamps in terms of lifetime and luminous efficacy may too be applicable to a UV CCFL lamp 100 of the present invention. Some comparative facts including such as CCFL lamps are of a relatively longer lifetime than incandescent and CFL lamps, having less mercury contains than CFL lamps and being capable of producing an illumination angle much greater than LED lamps are well know and will not be discussed in detail. Nevertheless, the UV CCFL lamp 100 of the present invention too shares the merits of CCFL lamp emitting light in the visible spectrum range. By utilizing a discharge medium 120 comprising an excited-ion-vapor plasma distributed throughout and sealed within the translucent hermetic lamp envelope 110, the UV CCFL lamp 100 of the present invention may produce a first emission spectrum of a UVC wavelength such as between 280 nm and 100 nm during operation. In an explanatory example of the present invention, the ion vapor plasma may be a mercury Hg-ion vapor excited to the ion plasma state by the high voltage power supply preferably in a range of one thousand volts or above. The UV irradiation produced by the excited ion vapor plasma may be of an emission spectrum of 280 nm and 100 nm and such initial or first UV irradiation may be further bombarded with or converted by a phosphor 130 disposed in the lamp envelope 110 and in contact with the ion vapor plasma to produce the initial UV irradiation of the first emission spectrum such as in the UVC spectrum range. Details of the UV-excited phosphor 130 to be disposed in the lamp envelope 110 of the present invention will be provided in the later content. In another embodiment of the present invention, said first emission spectrum produced by the excited-ion-vapor plasma of the discharge medium of ionized-mercury plasma may be of a spectrum in the range between 260 nm and 240 nm.

For an exemplary application of the UV CCFL lamp 100 of the present invention in the field of nail art, the UV CCFL lamp 100 may be preferably configured and provided for curing a UV curable nail gel. In one embodiment, the nail gel to be cured by the UV irradiation of the UV CCFL lamp 100 of present invention may of a composition comprising a first component having at least one radical polymerizable unsaturated double bond in the molecule and a second component of photopolymerization initiator and wherein the amount of the second component is 0.05 to 4.00 parts by weight with respect to 100 parts by weight of the first component. An example of such nail gel polymerizeable under the exposure to UV irradiation may make reference to JP Patent Application No. 2009-121506 “Artificial Nail Composition Having Excellent Appearance” by Tanaka et al. and JP Patent Application No. 2009-152449 “Artificial Nail Composition Having Improved Curability” by Tanaka et al. Tanaka discloses an example of such gel-type material suitable for nail gel and may be solidified and cured under a sufficient UV irradiation. The UV CCFL lamp 100 of the present invention may be used in conjunction with or may work collaboratively with such UV polymerizeable or curable nail gel to achieve an optimal result of artificial nail in the field of nail art. In addition, for a safer and healthier UV irradiation, the UV CCFL lamp 100 of the present invention may preferably provide a sufficient and uniform UV irradiation in the UVA spectrum range by utilizing a UV-excited phosphor 130 disposed in the abovementioned translucent hermetic lamp envelop 110 configured to facilitate the bombardment of said first UV irradiation produced by the mercury ion-vapor plasma 120 with the UV-excited phosphor powder 130 therein.

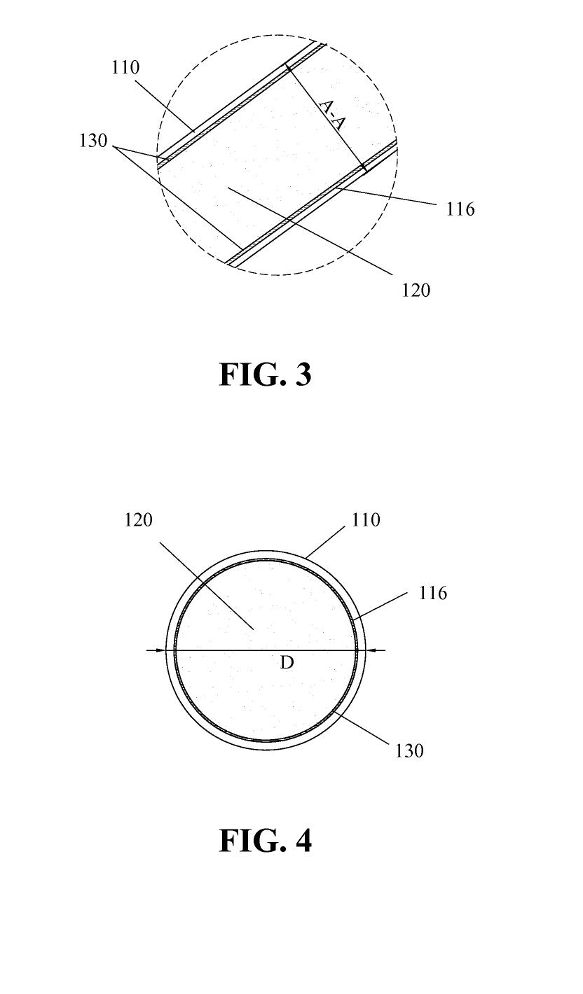

According to one embodiment of the present invention, the UV CCFL lamp 100 comprises a UV-exited phosphor 130 to produce or convert the abovementioned UV irradiation from UVC spectrum to non-UVC spectrum such as in a UVA wavelength range. The phosphor 130 may preferably be disposed within the translucent hermetic envelope 110 of the UV CCFL lamp 100 of the present invention and may too be in contact with said discharge medium 120. As an explanatory example shown in FIG. 3 of an enlarged view of a portion I of the lamp envelope 110 of the UV CCFL lamp 100 of the present invention, the phosphor 130 may be preferably disposed on an inner wall 116 of the lamp envelope 110. In one embodiment, the phosphor 130 may be of a composition comprising europium-doped boron strontium oxide (B₄SrO₇:Eu⁺). The phosphor 130 comprising the composition of B₄SrO₇:Eu⁺ may preferably be prepared in a powder form having a mean grain size pre-specified or selected for a phosphor mixture solution to be coated onto the inner wall 116 of the lamp envelope 110 of the UV CCFL lamp 100 of the present invention. The phosphor 130 provided on the lamp envelope 110 and in contact with the abovementioned discharge medium 120 may then produce said UV irradiation in response to said first emission spectrum of the discharge medium 120 during operation. In an explanatory example, the UV irradiation of the first emission spectrum may be a UVC irradiation having a wavelength between 280 nm and 100 nm, and more particularly, it may be preferably between 260 nm and 240 nm. An output UV irradiation produced or converted by said phosphor 130 via for example bombardments of said UVC irradiation of the discharge medium 120 with the phosphor 130 disposed in the lamp envelope 110 may preferably be of a second emission spectrum in a non-UVC wavelength range; in one embodiment, the output UV irradiation of the UV CCFL lamp 100 of the present invention produced in response to said first emission spectrum may be a UVA irritation having a wavelength between 400 nm and 350 nm. Furthermore, in an exemplary embodiment of the UV CCFL lamp 100 of the present invention utilizing the abovementioned phosphor 130 having a composition comprising B₄SrO₇:Eu⁺ therein, the second emission spectrum of the non-UVC irradiation produced by such phosphor 130 in response to the initial UV irradiation of the first emission spectrum produced by the discharge medium 120 may be of a UVA spectrum.

To achieve and generate an optimal UV irradiation output from a UV CCFL lamp 100 according to an exemplary embodiment of the present invention, the translucent hermetic envelope 110 as shown in the figure may preferably be configured to be of a shape and size facilitating the bombardment of the abovementioned phosphor with said initial UVC irritation to generate the desired or optimal UV irradiation in the non-UVC spectrum range or preferably UVA spectrum. In one embodiment of the present invention as shown in FIG. 4, the translucent hermetic envelope 110 may comprise a silica-based tube 116 of a substantially circular cross-section of a uniform diameter D and in a spiral form having two ends 112, 114. It may be preferable that the diameter D, or outer diameter, of the spiral tube of the translucent hermetic envelope 110 is between 2 mm and 10 mm (Ø2˜Ø10) and to be more specific, in an exemplary embodiment, it may preferably be 4 mm (Ø4). Furthermore, to achieve optimal UV irritation output from the UV CCFL lamp 100 of the present invention for curing a nail gel, the lamp envelope 110 may preferable be made of a non-UV absorbing and/or UV translucent material. In one embodiment, the abovementioned silica-based tube of the translucent hermetic envelope 110 of the UV CCFL lamp 100 may be quartz glass; in another embodiment, it may be UV-grade fused silica to facilitate the emission of the UV light ray or irradiation therethrough. Said two ends 112, 114 of the translucent hermetic lamp envelope 110 of the UV CCFL lamp 100 may be configured to receive the discharge electrodes 140 capable of providing high voltage electricity to excite the ion-vapor plasma of the discharge medium 120 in the lamp envelope 110. In other words, the discharge electrodes 140 configured on the two ends 112, 114 of the translucent hermetic envelope 110 are separated by a width W of substantially greater than or equal to 5 mm whereby the electricity supplied by the power supply of the lamp base 150 operates safely at a high voltage greater than one thousand volts; in one exemplary embodiment, the width W between said discharge electrodes 140 on the two ends 112, 114 of the lamp envelope 110 may be 20 mm.

Please refer to FIGS. 3 and 4 again. In addition to the above, in order to facilitate the bombardment of the phosphor 130 disposed in the translucent hermetic envelope 110 of the UV CCFL lamp 100 of the present invention such that the output of the UV irradiation, preferably in the UVA spectrum range, may be uniform and sufficient for curing a nail gel in the field of nail art. According to one embodiment of the UV CCFL lamp 100 of the present invention, in which the composition of europium-doped boron strontium oxide (B₄SrO₇:Eu⁺) of the phosphor 130 is utilized; the B₄SrO₇:Eu⁺ may be advantageously prepared to be of a mean grain size preferably between 12 μm and 18 μm. In one embodiment, the mean grain size of the phosphor 130 may preferably be substantially equal to 15 μm (or 15 μm±3 μm). In other words, the phosphor 130 may be advantageously prepared in a powder form having a mean grain size pre-specified or selected for a phosphor mixture solution to be coated onto the inner wall 116 of the lamp envelope 110 of the UV CCFL lamp 100 of the present invention as shown by the hatched portion in the figures. Such phosphor mixture solution may be advantageously provided and coated during an explanatory manufacturing process of the UV CCFL lamp 100 of the present invention. The phosphor 130 provided on the lamp envelope 110, particularly the abovementioned inner wall 116 thereof, and in contact with the abovementioned discharge medium 120 may then produce said UV irradiation in response to said first emission spectrum of the discharge medium 120 during operation. In addition, according to a further embodiment of the present invention and with regard to the discharge medium 120 disposed in the lamp envelope 110 of the UV CCFL 100 of the present invention, the ion-vapor plasma such as mercury Hg-ion vapor excited by the high voltage supplied via the discharge electrodes 140 and power supply of the lamp base 150 to a plasma state may be of a density of between 2.7 g/cm³ and 3.7 g/cm³ in the translucent hermetic envelope 110 of the UV CCFL lamp 100 of the present invention. In one embodiment, the excited-ion vapor such as mercury-ion vapor to be excited to a plasma state may preferably substantially be equal to 3.5 g/cm³ in the translucent hermetic envelope 110 of the UV CCFL lamp 100 of the present invention.

According to one embodiment of the present invention, the output UV irradiation provided by the UV CCFL lamp 100 may preferably be of a non-UVC wavelength providing a safer and healthier usage and application of the UV light, particularly for applications such as nail gel curing in the field of nail art. The abovementioned output UV irradiation having a second emission spectrum produced by the phosphor 130 in response to the first emission spectrum, such as between 260 nm and 240 nm, of the initial UV irradiation of the excited ion-vapor plasma may be of a UVA wavelength between 400 nm and 350 nm. In one embodiment of the present invention, the second emission spectrum produced by the abovementioned phosphor 130 comprising a composition of B₄SrO₇:Eu⁺ may preferably include a peak wavelength substantially equal to 368 nm.

According to another embodiment of the present invention, a UV CCFL lamp 100 for curing a UV curable nail gel with a UV irradiation may utilize a phosphor 130 comprising a composition of europium-doped strontium fluoborate (SrFB₂O₃₅:Eu²⁺). Likewise, a discharge medium 120 comprising an excited-ion vapor for producing a first emission spectrum of a UVC wavelength upon the discharging by a high voltage electricity input may too be provided or disposed in the translucent hermetic lamp envelope 110 such that it may be excited to a plasma state during the operation of the UV CCFL lamp 100 of the present invention. The phosphor 130 comprising the composition of SrFB₂O_{3.5}:Eu²⁺ may be advantageously prepared and disposed within the translucent hermetic lamp envelope 110, preferably on the abovementioned inner wall 116 of the lamp envelope 110, and in contact with said discharge medium 120 such that during operation and bombardment with the initial UVC irritation by the discharge medium 120, the output UV irradiation in response to said first emission spectrum of the discharge medium 120 may be of a second emission spectrum of a non-UVC wavelength, preferably a UVA wavelength such as between 400 nm and 350 nm.

Similarly, the UV curable nail gel to be utilized collaboratively or in conjunction with the UV irritation provided by the UV CCFL lamp 100 of the present invention may too be of a composition comprising a first component having at least one radical polymerizable unsaturated double bond in the molecule and a second component of photopolymerization initiator. As mentioned previously, the amount of the second component is 0.05 to 4.00 parts by weight with respect to 100 parts by weight of the first component. The UV curable gel may be transformed from a liquid-state to a solid state under the exposure of the output UV irradiation of the UV CCFL lamp 100 of the present invention; in addition, the curing result of the UV curable nail gel may too be dependent upon the wattage of the UV CCFL lamp 100 of the present invention and the duration of curing time under such UV irradiation exposure. Additionally, examples of a UV curable nail gel, such as an acrylic type gel including urethane-methacrylate and epoxy-methacrylate may too include or make reference to the ones from manufacturers such as Keystone®, BIO®, CNC®, COSMEX™. The introduction of an UV CCFL kit that may include the UV CCFL lamp 100 of the present invention together with any UV curable nail gel shall too be considered to be within the scope of the present invention.

According to an exemplary embodiment of an UV CCFL lamp 100 of the present invention, in which a discharge medium 120 comprising an excited-ion vapor, such as mercury-ion vapor to be excited to a plasma state during operation of the lamp, distributed throughout and sealed within the translucent hermetic envelope 110 thereof for producing a first emission spectrum of a UVC wavelength preferably between 260 nm and 240 nm and a phosphor 130 disposed within the translucent hermetic envelope 110 and in contact with said discharge medium 120 for producing an output UV irradiation having a second emission spectrum of a non-UVC wavelength preferable between 400 nm and 350 nm in response to said first emission spectrum of the discharge medium 120. The phosphor 130 may comprise a composition of the abovementioned SrFB₂O_{3.5}:Eu²⁺ and may be advantageously prepared to be of a mean grain size preferably between 5.5 μm and 11.5 μm. In one embodiment, the mean grain size of the phosphor 130 may preferably be substantially equal to 8.5 μm (or 8.5 μm±3 μm). In other words, the phosphor 130 may be advantageously prepared in a powder form having a mean grain size pre-specified or selected for a phosphor mixture solution to be coated onto the inner wall 116 of the lamp envelope 110 of the UV CCFL lamp 100 of the present invention such as during an explanatory manufacturing process of the UV CCFL lamp 100 of the present invention. The phosphor 130 provided on the lamp envelope 110, particularly the abovementioned inner wall 116 thereof, and in contact with the abovementioned discharge medium 120 may then produce said UV irradiation in response to said first emission spectrum of the discharge medium 120 during operation. In addition, according to a further embodiment of the present invention and with regard to the discharge medium 120 disposed in the lamp envelope 110 of the UV CCFL 100 of the present invention, the ion-vapor plasma such as mercury Hg-ion vapor excited by the high voltage supplied via the discharge electrodes 140 and power supply of the lamp base 150 to a plasma state may be of a density of between 2.7 g/cm³ and 3.7 g/cm³ in the translucent hermetic envelope 110 of the UV CCFL lamp 100 of the present invention. In one embodiment, the excited-ion vapor such as mercury-ion vapor to be excited to a plasma state may preferably substantially be equal to 3.5 g/cm³ in the translucent hermetic envelope 110 of the UV CCFL lamp 100 of the present invention.

Likewise, according to one embodiment of the present invention, the output UV irradiation provided by the UV CCFL lamp 100 may preferably be of a non-UVC wavelength providing a safer and healthier usage and application of the UV light, particularly for applications such as nail gel curing in the field of nail art. The abovementioned output UV irradiation having a second emission spectrum produced by the phosphor 130 in response to the first emission spectrum, such as between 260 nm and 240 nm, of the initial UV irradiation of the excited ion-vapor plasma may be of a UVA wavelength between 400 nm and 350 nm. In one embodiment of the present invention, the second emission spectrum produced by the abovementioned phosphor 130 comprising a composition of SrFB₂O_{3.5}:Eu²⁺ may preferably include a peak wavelength substantially equal to 366 nm.

Please refer to FIGS. 1 and 2 again. As part of the safety measures for a device operating at high voltage, the abovementioned at least one discharge electrodes 130 configured on the two ends 112, 114 of the translucent hermetic envelope 110 of the UV CCFL lamp 100 of the present invention may preferably be separated by a width W of substantially greater than or equal to 5 mm and whereby the electricity supplied by the power supply of the lamp base 150 may operate safely at a high voltage greater than one thousand volts. In one exemplary embodiment, the width W between said discharge electrodes 140 on the two ends 112, 114 of the lamp envelope 110 may be 20 mm. In addition, the lamp base 150 coupled to said translucent hermetic envelope 110 and configured to receive said at least one discharge electrodes may too comprise a power supply for supplying an electricity to excite said discharge medium 120 to a plasma state such as mercury-ion vapor plasma.

During an exemplary operation of the UV CCFL lamp 100 of the present invention, particularly in the application in the field of nail art, a nail gel may be preferably utilized collaboratively and in conjunction with the UV CCFL lamp 100 and may be applied on the nails of fingers or toes of a user such that the UV curable nail gel may be polymerized or cured upon the exposure to the UV irradiation outputted by the UV CCFL lamp 100. As electricity at a high voltage is supplied via the power supply of the lamp base 150 having a lamp socket electrically connected to such as an on-grid power input and to the discharge electrodes 140 of the UV CCFL lamp 100 of the present invention, the discharge medium 120 disposed in the translucent hermetic lamp envelope 110 thereof such as a mercury vapor may be excited to an ion-vapor plasma and may emit an initial UV irradiation of a first spectrum in the UVC range of 260 nm-240 nm. As a UV-excited phosphor 140 comprising a composition of either the abovementioned B₄SrO₇:Eu⁺ or SrFB₂O_{3.5}:Eu²⁺ may too be preferably provided and disposed in the lamp envelope 110 and in contact with the discharge medium 120, an output UV irradiation of a second spectrum preferably in the UVA range of 400 nm-350 nm may be obtained via the bombardment of the initial UV irradiation with the phosphor powder or in response to the UV irradiation of the first spectrum. The nail gel applied on the nails of a user and preferably including a composition comprising a first component having at least one radical polymerizable unsaturated double bond in the molecule and a second component of photopolymerization initiator may then be cured to achieve an optimal result of an artificial nail after such curing process as the UV CCFL lamp 100 of the present invention may work collaboratively with such nail gel effectively with great safety in terms of the spectrum of the UVA irradiation provided by the present invention and the relatively shorter curing time with reference to a specific wattage of the UV CCFL lamp 100 of the present invention.

While the present invention is disclosed in reference to the preferred embodiments or examples above, it is to be understood that these embodiments or examples are intended for illustrative purposes, which shall not be treated as limitations to the present invention. It is contemplated that modifications and combinations will readily occur to those skilled in the art, which modifications and combinations will be within the spirit of the invention and the scope of the following claims.

What is claimed is:

1. A UV CCFL lamp for curing a UV curable nail gel with a UV irradiation, wherein the nail gel is of a composition comprising a first component having at least one radical polymerizable unsaturated double bond in the molecule and a second component of photopolymerization initiator and wherein the amount of the second component is 0.05 to 4.00 parts by weight with respect to 100 parts by weight of the first component, said UV CCFL lamp comprising:
a translucent hermetic envelope, comprising a silica-based tube of a substantially circular cross-section of a uniform diameter and in a spiral form having two ends;
at least one discharge electrodes configured at the two ends of the translucent hermetic envelope;
a discharge medium comprising an excited-ion vapor distributed throughout and sealed within the translucent hermetic envelope for producing a first emission spectrum of a UVC wavelength;
a phosphor disposed within the translucent hermetic envelope and in contact with said discharge medium, comprising a composition of europium-doped boron strontium oxide (B₄SrO₇:Eu⁺) for producing said UV irradiation in response to said first emission spectrum of the discharge medium; wherein said UV irradiation having a second emission spectrum of an non-UVC wavelength; and
a lamp base coupled to said translucent hermetic envelope and configured to receive said at least one discharge electrodes, comprising a power supply for supplying an electricity to excite said discharge medium.

2. The UV CCFL lamp as claimed in claim 1, wherein said UVC wavelength of the first emission spectrum produced by the discharge medium is between 260 nm and 240 nm.

3. The UV CCFL lamp as claimed in claim 1, wherein said non-UVC wavelength of the second emission spectrum produced by the phosphor in response to the first emission spectrum is a UVA wavelength between 400 nm and 350 nm.

4. The UV CCFL lamp as claimed in claim 1, wherein the europium-doped boron strontium oxide (B₄SrO₇:Eu⁺) of the phosphor is of a mean grain size between 12 μm and 18 μm.

5. The UV CCFL lamp as claimed in claim 1, wherein the second emission spectrum produced by the phosphor includes a peak wavelength substantially equal to 368 nm.

6. The UV CCFL lamp as claimed in claim 1, wherein the discharge medium comprising excited-ion vapor excited to a plasma state is of a density of between 2.7 g/cm³ and 3.7 g/cm³ in the translucent hermetic envelope.

7. The UV CCFL lamp as claimed in claim 1, wherein the diameter of the spiral tube of the translucent hermetic envelope is between 2 mm and 10 mm.

8. The UV CCFL lamp as claimed n claim 1, wherein the excited-ion vapor of the discharge medium is mercury-ion vapor excited to a plasma state.

9. The UV CCFL lamp as claimed in claim 1, wherein the silica-based tube of the translucent hermetic envelope is quartz glass.

10. The UV CCFL lamp as claimed in claim 1, wherein the at least one discharge electrodes configured on the two ends of the translucent hermetic envelope are separated by a width of substantially greater than or equal to 5 mm whereby the electricity supplied by the power supply of the lamp base operates safely at a high voltage greater than one thousand volts.

11. A UV CCFL lamp for curing a UV curable nail gel with a UV irradiation, wherein the nail gel is of a composition comprising a first component having at least one radical polymerizable unsaturated double bond in the molecule and a second component of photopolymerization initiator and wherein the amount of the second component is 0.05 to 4.00 parts by weight with respect to 100 parts by weight of the first component, said UV CCFL lamp comprising:
a translucent hermetic envelope, comprising a silica-based tube of a substantially circular cross-section of a uniform diameter and in a spiral form having two ends;
at least one discharge electrodes configured at the two ends of the translucent hermetic envelope;
a discharge medium comprising an excited-ion vapor distributed throughout and sealed within the translucent hermetic envelope for producing a first emission spectrum of a UVC wavelength;
a phosphor disposed within the translucent hermetic envelope and in contact with said discharge medium, comprising a composition of europium-doped strontium fluoborate (SrFB₂O_{3.5}:Eu²⁺) for producing said UV irradiation in response to said first emission spectrum of the discharge medium; wherein said UV irradiation having a second emission spectrum of a non-UVC wavelength; and
a lamp base coupled to said translucent hermetic envelope and configured to receive said at least one discharge electrodes, comprising a power supply for supplying an electricity to excite said discharge medium.

12. The UV CCFL lamp as claimed in claim 11, wherein said UVC wavelength of the first emission spectrum produced by the discharge medium is between 260 nm and 240 nm.

13. The UV CCFL lamp as claimed in claim 11, wherein said non-UVC wavelength of the second emission spectrum produced by the phosphor in response to the first emission spectrum is a UVA wavelength between 400 nm and 350 nm.

14. The UV CCFL lamp as claimed in claim 11, wherein the europium-doped strontium fluoborate (SrFB₂O_{3.5}:Eu²⁺) of the phosphor is of a mean grain size between 5.5 μm and 11.5 μm.

15. The UV CCFL lamp as claimed in claim 11, wherein the second emission spectrum produced by the phosphor includes a peak wavelength substantially equal to 366 nm.

16. The UV CCFL lamp as claimed in claim 11, wherein the discharge medium comprising excited-ion vapor excited to a plasma state is of a density between 2.7 g/cm³ and 3.7 g/cm³ in the translucent hermetic envelope.

17. The UV CCFL lamp as claimed in claim 11, wherein the diameter of the spiral tube of the translucent hermetic envelope is between 2 mm and 10 mm.

18. The UV CCFL lamp as claimed n claim 11, wherein the excited-ion vapor of the discharge medium is mercury-ion vapor excited to a plasma state.

19. The UV CCFL lamp as claimed in claim 11, wherein the silica-based tube of the translucent hermetic envelope is quartz glass.

20. The UV CCFL lamp as claimed in claim 11, wherein the at least one discharge electrodes configured on the two ends of the translucent hermetic envelope are separated by a width of substantially greater than or equal to 5 mm whereby the electricity supplied by the power supply of the lamp base operates safely at a high voltage greater than one thousand volts.
